(19) United States
(12) Patent Application Publication
(10) Pub. No.: US 2014/0068012 A1
(43) Pub. Date: Mar. 6, 2014

(54) METHOD AND SYSTEM FOR DOWNLOADING TEACHING MATERIAL

(71) Applicant: WISTRON CORPORATION, New Taipei City (TW)

(72) Inventor: Chia-Chieh Liu, New Taipei City (TW)

(73) Assignee: Wistron Corporation, New Taipei City (TW)

(21) Appl. No.: 13/888,378

(22) Filed: May 7, 2013

(30) Foreign Application Priority Data
Aug. 30, 2012 (TW) 101131583

(51) Int. Cl. H04L 29/08

(52) U.S. Cl. CPC H04L 67/02
USPC 709/219

(57) ABSTRACT

A method and a system for downloading teaching material are provided. The system for downloading teaching material includes a handheld electronic apparatus and a server. A time difference between a current time and a class time of a teaching material item is calculated when the handheld electronic apparatus desire to download the teaching material data corresponding to the teaching material item, and a loading weight is calculated according to the time difference and a weighted value of the teaching material item so as to send a loading request with the loading weight to the server, such that the server decides a transmission order of teaching material data corresponding to the teaching material item.

### CROSS-REFERENCE TO RELATED APPLICATION

This application claims the priority benefit of Taiwan application serial no. 101131583, filed on Aug. 30, 2012. The entirety of the above-mentioned patent application is hereby incorporated by reference herein and made a part of this specification.

### BACKGROUND

1. Field of the Invention

The present invention is directed to a mechanism of data downloading and more particularly, to a method and a system for downloading teaching material.

2. Description of Related Art

With the development of technology, people are more and more relying on electronic devices. Today's users are demanding the electronic devices to have features of higher operation performance, light weight and compactness. Therefore, various types of handheld electronic apparatuses, such as ultra mobile personal computers (UMPCs), tablet computers (tablet PCs), pocket PCs, personal digital assistants (PDAs), cellular phones and notebook PCs are developed accordingly.

In addition, with the rapid buildup of digital products and popularization of various types of handheld electronic apparatuses, applying a handheld electronic apparatus as an electronic book (e-book) package appears to be a trend in the future. In an electronic education system using two types of hardware, such as a handheld electronic apparatus (e.g. an e-book package) and a server for the users, i.e. students and teachers, the teachers may upload teaching material data files to the server for the students to download. A student may use a handheld electronic apparatus to download the teaching material data files that are stored in the server to his/her own personal computer. Thus, the student may use the teaching material data files for studying.

However, if the server is crowded with too many connections of downloading requests at the same time, the loading of the server becomes heavier such that the operation becomes slower. Meanwhile, due to problems of network bandwidth or file sizes, some students may encounter the problem that they can not finish loading the teaching material data in their own computers before the class starts.

### SUMMARY

The present invention is directed to a method and system for downloading teaching material, by which the downloading priority may be decided according to the importance of teaching material.

The present invention is directed to a method for downloading teaching material, which is applicable to a handheld electronic apparatus. The method includes the following steps. A list of teaching material information is displayed, wherein the list of the teaching material information includes a plurality of teaching material items. A class time of a target item to be downloaded is read, wherein the target item is one of the teaching material items. A time difference between a current time and the class time is calculated. A loading weight of the target item is calculated according to the time difference and a weighted value of the target item. A loading request having the loading weight is transmitted to a server so that the server decides a transmission order of teaching material data corresponding to target item.

The present invention is further directed to a method for downloading teaching material, which is applicable to a system for downloading teaching material. The teaching material includes a handheld electronic apparatus and a server. The method includes the following steps. A loading request is transmitted to the server via the handheld electronic apparatus. The loading request is received via the server to transmit teaching material data corresponding to a target item to the handheld electronic apparatus. The step of transmitting the loading request having a loading request via the handheld electronic apparatus to the server includes the following steps. One of the teaching material items is applied as a target item. A time difference between a current time and a class time of the target item is calculated. A loading weight is calculated according to a time difference and a weighted value of the target item. The loading request having the loading weight is generated and transmitted to the server. Besides, the step of receiving the loading request via the server to transmit the teaching material data corresponding to the target item to the handheld electronic apparatus includes the following steps. A priority degree of the target item is obtained according to the loading request, and the loading request is sorted into a corresponding waiting queue based on the priority degree to process the loading request according to a transmission order corresponding to the waiting queue.

In addition, the present invention is directed to a system for downloading teaching material, which includes a handheld electronic apparatus and a server. The handheld electronic apparatus includes a first processing unit and a first communication unit. The first communication unit is coupled to the first processing unit to transmit a loading request. The first processing unit applies one of a plurality of teaching material items as a target item to calculate a time difference between a current time and a class time of the target item and calculates a loading weight according to the time difference and a weighted value of the target item to generate a loading request according to a priority degree corresponding to the loading weight. Besides, the server includes a second processing unit, a second communication unit and a storing unit. The second processing unit is coupled to the storing unit and the second communication unit. The storing unit includes a teaching material database and a plurality of waiting queues. The teaching material database includes a plurality of teaching material items. The waiting queues have different transmission order, respectively. The second communication unit is configured to receive the loading request. The second processing unit obtains a priority degree of the target item according to the loading request, sorts the loading request into one of the corresponding waiting queues based on the priority degree and processes the loading request according to the transmission order corresponding to the waiting queue.

To sum up, in the present invention, the downloading priority may be decided according to the importance of the teaching material items. Namely, the loading weight is decided according to the time difference between the current time and the class time and the weighted value of the target item, and thus, the transmission order is decided by the server so as to avoid the important teaching material item being delayed for downloading.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a schematic diagram illustrating a system for downloading teaching material according to an embodiment of the present invention.

FIG. 2 is a block diagram illustrating a handheld electronic apparatus according to an embodiment of the present invention.

FIG. 3 is a block diagram illustrating a server according to an embodiment of the present invention.

FIG. 4 is flowchart illustrating a method for downloading teaching material applicable to a handheld electronic apparatus according to an embodiment of the present invention.

FIG. 5 is flowchart illustrating a method for downloading teaching material applicable to the handheld electronic apparatus according to another embodiment of the present invention.

FIG. 6 is flowchart illustrating a method for downloading teaching material applicable to the server according to an embodiment of the present invention.

FIG. 7 is flowchart illustrating a method for downloading teaching material applicable to the system for downloading teaching material according to an embodiment of the present invention.

### DESCRIPTION OF EMBODIMENTS

Once a server is crowded with too many connections at the same time, the lag will occur in the operation of the server, and the speed for downloading teaching material data will dramatically slow due to problems of network bandwidth or file sizes. Accordingly, the present invention is directed to a method and system for downloading teaching material, wherein the downloading priority may be decided according to the importance of teaching material items representing different types of teaching material data so as to avoid the important teaching material items from being delayed for downloading. In order to make the content of the present invention more comprehensible, several embodiments will be illustrated accompanied with figures are described in detail below. In order to make the content of the present invention clearer, the following embodiments are illustrated as examples that can be truly implemented by the present invention.

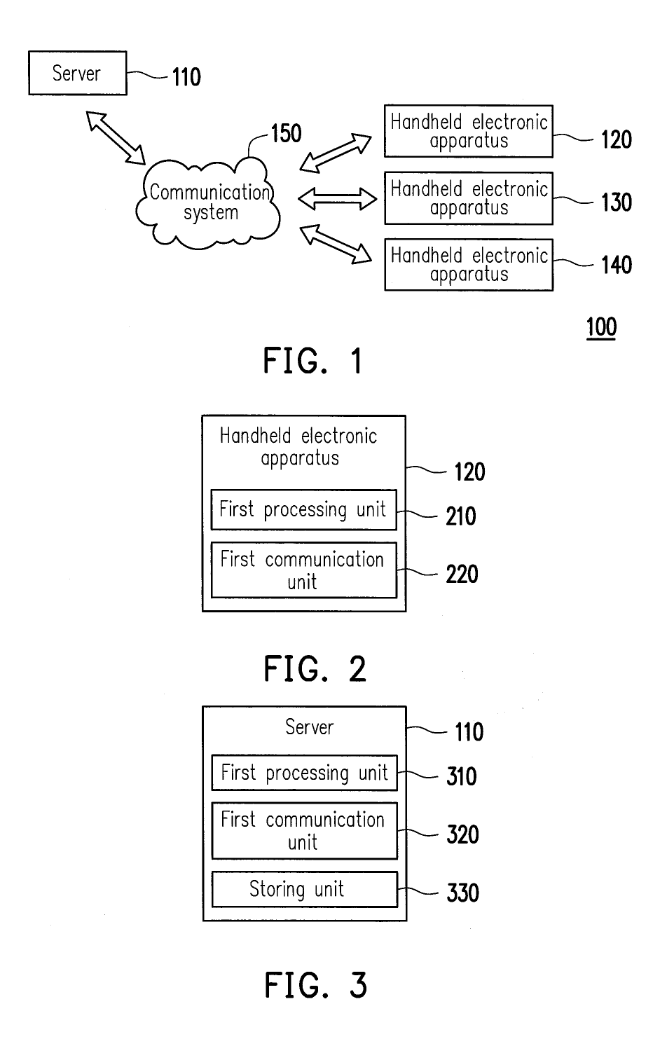

FIG. 1 is a schematic diagram illustrating a system for downloading teaching material according to an embodiment of the present invention. Referring to FIG. 1, a teaching material downloading system 100 includes a server 110 and a plurality of handheld electronic apparatuses 120, 130 and 140. In the present embodiment, the three handheld electronic apparatuses 120, 130 and 140 are illustrated as examples. However, in other embodiments, the teaching material downloading system 100 may also include only one handheld electronic apparatus, two handheld electronic apparatuses or three or more handheld electronic apparatuses, and the present invention is not intent to limit the number of the handheld electronic apparatuses.

For example, the server 110 is, for example, an electronic apparatus having powerful processing capability and provides users, such as teachers, with a platform for uploading teaching material data and meanwhile, provides students with a platform for downloading the teaching material data. The handheld electronic apparatuses 120, 130 and 140 are electronic apparatuses equipped with communication and processing functions, such as smart phones, personal digital assistants (PDAs), tablet computers, notebook computers. A communication system 150 is, for example, a local area network (LAN), an Internet, a wireless fidelity (Wi-Fi) system, a Bluetooth communication system or any other type of wired or wireless communication system.

The server 110 is communicated with the handheld electronic apparatuses 120, 130 and 140 through the communication system 150. For instance, the teaching material data as desired is downloaded from the server 110 to the handheld electronic apparatuses 120, 130 and 140 through the communication system 150.

Major elements of the server 110 and the handheld electronic apparatuses 120, 130 and 140 will be described hereinafter. FIG. 2 is a block diagram illustrating a handheld electronic apparatus according to an embodiment of the present invention. FIG. 3 is a block diagram illustrating a server according to an embodiment of the present invention. In FIG. 2, the handheld electronic apparatus 120 is illustrated as an example. However, the other handheld electronic apparatuses (e.g. the handheld electronic apparatuses 130 and 140) in the teaching material downloading system 100 have major elements that are the same as those in the handheld electronic apparatus 120.

In FIG. 2, the handheld electronic apparatus 120 includes a first processing unit 210 and a first communication unit 220. Here, the first processing unit 210 applies a teaching material item (a teaching material item to be downloaded) as a target item and transmits a loading request to the server 110.

Here, a storing unit (not shown) of the handheld electronic apparatus 120 stores one or more procedures. After being installed, the procedures are executed by the first processing unit 210. The procedures contain a plurality of instructions. The first processing unit 210 performs a plurality of steps by using the instructions. In the present embodiment, the handheld electronic apparatus 120 only includes a first processing unit 210. However, in other embodiments, the handheld electronic apparatus 120 may include multiple first processing units 210 for executing the installed procedures.

For example, the first processing unit 210 calculates a time difference between a current time and a class time of the target item and calculates a loading weight according to the time difference and a weighted value of the target item, such that a loading request having the loading weight is generated. Then, the loading request is transmitted to the server 110 by the first communication unit 220.

Besides, referring to FIG. 3, the server 110 includes a second processing unit 310, a second communication unit 320 and a storing unit 330. The storing unit 330 includes a teaching material database and a plurality of waiting queues. Here, the teaching material database contains teaching material data corresponding to a plurality of teaching material items, and the waiting queues are provided with different transmission orders, respectively.

Additionally, the storing unit 330 in the server 110 stores one or more procedures. After being installed, the procedures are executed by the second processing unit 310. The procedures contain a plurality of instructions. The second processing unit 310 performs a plurality of steps by using the instructions. In the present embodiment, the server 110 only includes a second processing unit 310. However, in other embodiments, the server 110 may include multiple second processing units 310 for executing the installed procedures.

When the second processing unit 310 receives the loading request through the second communication unit 320, the second processing unit 310 provides teaching material data corresponding to target item according to the loading request for the handheld electronic apparatus 120 to download. For example, the second processing unit 320 obtains a priority degree of the target item according to the loading request and sorts the loading request into one of the waiting queues based on the priority degree so as to process the loading request according to a transmission order corresponding to the waiting queue.

For example, in the handheld electronic apparatus 120, the first processing unit 210 may generate a loading request based on a priority degree corresponding to the loading weight. When receiving the loading instruction, the server 110 directly obtains the priority degree from the loading request. Alternatively, the loading request having the loading weight may be directly transmitted to the server 110. When receiving the loading instruction, the server 110 obtains the loading weight from the loading request through the second processing unit 310 and further obtains the corresponding priority degree according to the loading weight.

The processes of a teaching material downloading method respectively applicable to the handheld electronic apparatus 120 and the server 110 will be described hereinafter.

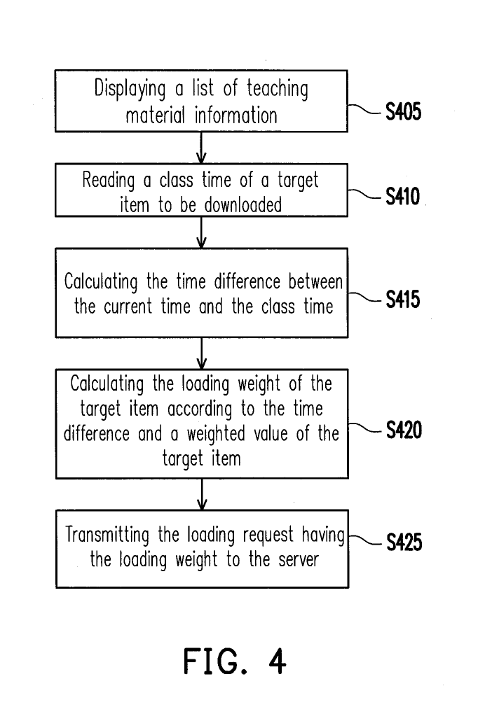

FIG. 4 is flowchart illustrating a method for downloading teaching material applicable to a handheld electronic apparatus according to an embodiment of the present invention. Here, only the handheld electronic apparatus 120 is illustrated as an example, and likewise, the method may also be applicable to the handheld electronic apparatuses 130 and 140, which will not be repeated.

Referring to FIG. 4 with FIG. 1 and FIG. 2, in step S405, a list of teaching material information is displayed on a display (not shown) of the handheld electronic apparatus 120. The list of the teaching material information contains a plurality of teaching material items. For example, the list of the teaching material information is a class schedule. After the handheld electronic apparatus 120 is connected with the server 110, the first processing unit 210 obtains the class schedule for a user of the handheld electronic apparatus 120 from the server 110 through the first communication unit 220. For example, the server 110 verifies the user identification of the handheld electronic apparatus 120 according to the user's login account.

Then, in step S410, a class time of a target item to be downloaded is read by the first processing unit 210. For example, if the class time of the target item is 10:00, and a current time is 8:00, a time difference calculated by the first processing unit 210 is 120 minutes. Besides, in other embodiments, a second may also be used as a unit for calculating the time difference, and the present invention is not intent to limit using a minute for calculating the time difference.

Next, in step S415, the first processing unit 210 calculates the time difference between the current time and the class time and, in step S420, calculates a loading weight of the target item according to the time difference and a weighted value of the target item. If a weighted value of the target item is −1000, and the time difference is 120 minutes, the loading weight is, for example, 120+(−1000).

Further, in other embodiments, the loading weight may also be calculated based on a formula as follows:

W=aT+bV.

Therein, the parameter W represents the loading weight, the parameter T represents the time difference between the current time and the class time, the parameter V represents the weighted value of the target item, and the parameters a and b respectively represent an importance degree of the time difference and an importance degree of the weighted value, wherein a plus b is equal to 1. In the meantime, the importance degree of the time difference and the importance degree of the weighted value are adjusted by the parameters a and b. For example, when the class time and the current time are more approximate to each other, the priority of the target item used by the user is higher, and thus, the importance degree of the time difference may be emphasized by the parameter a.

Afterward, as shown in step S425, the first processing unit 210 transmits the loading request having the loading weight to the server 110. When receiving the loading request, the server 110 decides a transmission order corresponding to the target item according to the loading request.

Moreover, attributes of the teaching material item are further classified into an initiative category and a passive category. A teaching material item belonging to the initiative category are automatically applied as a target item and downloaded. A teaching material item belonging to the passive category is selectively downloaded, and the user decides on his/her own whether to download the teaching material item belonging to the passive category. An example is illustrated hereinafter.

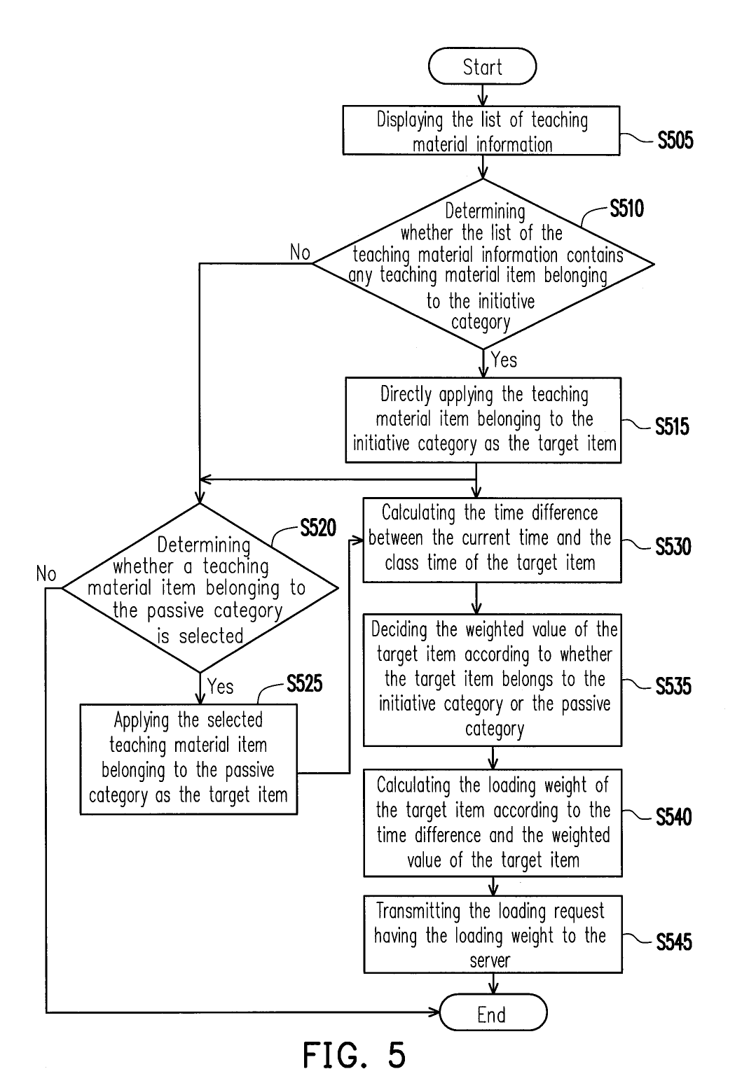

FIG. 5 is flowchart illustrating a method for downloading teaching material applicable to the handheld electronic apparatus according to another embodiment of the present invention. In this case, only the handheld electronic apparatus 120 is illustrated as an example, and likewise, the method may also be applicable to the handheld electronic apparatuses 130 and 140, which will not be repeated.

Referring to FIG. 5 with FIG. 1 and FIG. 2, in step S505, a list of teaching material information is displayed on the display (not shown) of the handheld electronic apparatus 120. The list of the teaching material information contains a plurality of teaching material items.

Then, in step S510, the first processing unit 210 determines whether the list of the teaching material information contains any teaching material item belonging to the initiative category. If the teaching material items contains a teaching material item belonging to the initiative category, as shown in step S515, the first processing unit 210 directly applies the teaching material item belonging to the initiative category as the target item, and thereafter, the first processing unit 210 perform steps S530˜S545.

Otherwise, if the teaching material item does not contain any teaching material item belonging to the initiative category, as shown in step S520, the first processing unit 210 determines whether a teaching material item belonging to the passive category is selected. If one of the teaching material items belonging to the passive category is selected, as shown in step S525, the first processing unit 210 applies the selected teaching material item belonging to the passive category as the target item, and thereafter, the first processing unit 210 performs steps S530˜S545.

In addition, after step S515, the first processing unit 210 may also perform step S520 to determine whether any teaching material items belonging to the passive category is selected. Otherwise, in other embodiments, the first processing unit 210 may also simultaneously perform step S10 and step S20. If the teaching material items contain no teaching material item belonging to the initiative category nor any teaching material item belonging to the passive category is selected, the process for downloading the teaching material is ended.

After the target item is decided, in step S530, the first processing unit 210 calculates the time difference between the current time and the class time of the target item. Meanwhile, in step S535, the weighted value of the target item is decided based on whether the target item belongs to the initiative category or the passive category. However, in other embodiments, the weighted value of each teaching material item may be decided by an uploader (e.g. a teacher). Or, the weighted value of the teaching material item may be decided by the server 110 after the uploader uploads the teaching material data and selects the attribute of the teaching material data corresponding to the teaching material item as belonging to the initiative category or the passive category. For example, the server 110 assigns the teaching material item with a corresponding weighted value through the second processing unit 310 according an uploading time or the attribute of the teaching material item.

Afterward, in step S540, the first processing unit 210 calculates the loading weight of the target item according to the time difference and the weighted value of the target item. Next, in step S545, the first processing unit 210 transmits the loading request having the loading weight to the server 110 through the first communication unit 220. Here, steps S540 and S545 are the same or similar to steps S420 and S425 as described above, respectively.

Furthermore, when there are several teaching material items to be downloaded, the first processing unit 210, for example, may apply each teaching material item as the target item one by one according to the arrangement sequence in the list of the teaching material information so as to perform performs steps S530˜S545.

When receiving the loading request, the server 110 decides a transmission order for the corresponding target item according to the loading request.

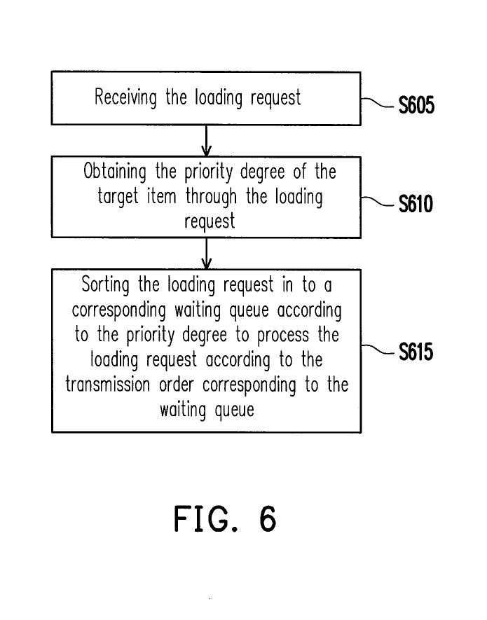

FIG. 6 is flowchart illustrating a method for downloading teaching material applicable to the server according to an embodiment of the present invention. Referring to FIG. 6 with FIG. 1 through FIG. 3, after the handheld electronic apparatus 120 transmits the loading request to the server 110, in step S605, the server 110 receives the loading request from the handheld electronic apparatus 120. Then, in step S610, the second processing unit 310 obtains the priority degree of the target item through the loading request.

For example, in the handheld electronic apparatus 120, the first processing unit 210 obtains the corresponding priority degree according to the loading weight. For example, the first processing unit 210 compares the loading weight with a plurality of thresholds to obtain the priority degree of the loading weight. Then, the first processing unit 210 packages the priority degree into the loading request to transmit the loading request to the server 110. Thus, the server 110 is aware of a priority degree from the loading request.

Besides, in the handheld electronic apparatus 120, the loading request having the loading weight may be transmitted before obtaining the priority degree. And, in server 110, the corresponding priority degree is obtained according to the loading weight through the second processing unit 310. The way to obtain the priority degree is similar to the above and will not be repeated hereinafter. The present invention is not intent to limit the priority degree being packaged into the loading request.

Afterward, in step S615, the second processing unit 310 sorts the loading request in to a corresponding waiting queue according to the priority degree to process the loading request according to the transmission order corresponding to the waiting queue. Additionally, when the waiting queue contains multiple loading requests, the server 110 processes each of the loading request based on a first-in, first-out (FIFO) principle.

In the present embodiment, the server 110 contains N+1 waiting queues, which are assigned numbers as 1˜N+1. Given that the waiting queue 1 has the highest priority to be processed, and the waiting queue N+1 has the lowest priority to be processed. Namely, the waiting queue assigned with the smaller number has the higher priority to be processed. That is, transmission orders of the waiting queue 1 through the waiting queue N+1 are arranged in the priority sequence as the waiting queue 1>the waiting queue 2> . . . the waiting queue N>the waiting queue N+1.

Further, given that the priority degrees are also assigned with numbers 1˜N+1, the loading request having the priority degree 1 is sorted into the waiting queue 1, the loading request having the priority degree 2 is sorted into the waiting queue 2 and so forth. Another example is illustrated hereinafter.

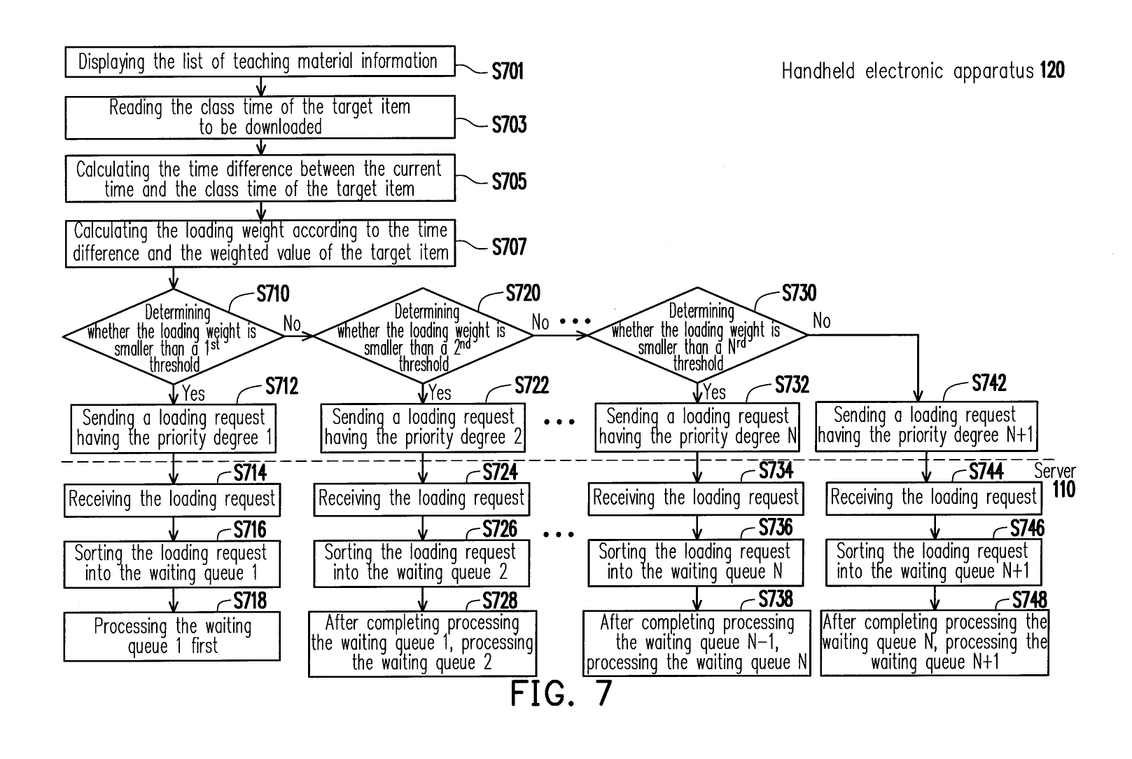

FIG. 7 is flowchart illustrating a method for downloading teaching material applicable to the system for downloading teaching material according to an embodiment of the present invention. For descriptive convenience, only the handheld electronic apparatus 120 and the server 110 are illustrated for description, which is applicable to the handheld electronic apparatuses 130 and 140, likewise.

Referring to FIG. 7 with FIG. 1 through FIG. 3, in step S701, the list of the teaching material information is displayed in the display (not shown) of the handheld electronic apparatus 120. In step S703, the class time of the target item to be downloaded is read via the first processing unit 210. Then, in step S705, the first processing unit 210 calculates the time difference between the current time and the class time. Meanwhile, in step S707, the first processing unit 210 calculates the loading weight of the target item according to the time difference and the weighted value of the target item.

In the present embodiment, N thresholds are set for being compared with the loading weight. Further, it is given that the weighted value is set as a negative number, and thus, the smaller weighted value represents the higher importance. For example, a weighted value of −1000 has a higher importance than a weighted value of −100. Accordingly, the smaller value of the loading weight represents that the priority degree is higher. Thus, in the present embodiment, the loading weight is compared with each set threshold based on whether the loading weight is smaller than each set threshold. However, in other embodiments, the loading weight may be decided whether to be smaller or greater than the thresholds based on the setting of the weighted value to determine the priority degree.

After the loading weight is calculated, in step S710, the first processing unit 210 determines whether the loading weight is smaller than a 1^{st} threshold. If true, step S712 is performed and the first processing unit 210 sends a loading request having the priority degree 1.

If the loading weight is not smaller than the 1^{st} threshold, step S720 is performed, and the first processing unit 210 determines whether the loading weight is smaller than a 2^{nd} threshold. If true, step S722 is performed to send a loading request having the priority degree 2.

Likewise, if the loading weight is not smaller than the 2^{nd} threshold, the loading weight is continuously compared with a 3^{rd} threshold, a 4^{th} threshold until an N^{th} threshold. Namely, in step S730, whether the loading weight is smaller than the N^{th} threshold is determines. If true, step S732 is performed to send a loading request having the priority degree N. If not, step S742 is performed to send a loading request having the priority degree N+1. Here, the priority degree 1 is the highest priority degree, while the priority degree N+1 is the lowest priority degree.

Thereafter, after the server 110 receives the loading request (i.e. after steps S714, S724, S734 and S744), the second processing unit 310 sorts the loading request into a corresponding waiting queue based on the priority degree (steps S716, S726, S736 and S746) and then, executes each waiting queue according to the transmission order of each waiting queue (steps S718, S728, S738 and S748).

In detail, if the loading weight is smaller than the 1^{st} threshold, the handheld electronic apparatus 120 performs step S712 and then the server 110 performs steps S714˜S718. Namely, in the server 110, the loading request is received and sorted into the waiting queue 1, and then, the waiting queue 1 has the priority to be processed.

If the loading weight is greater than the 1^{st} threshold, but smaller than the 2^{nd} threshold, the handheld electronic apparatus 120 perform step S722, and them the server 110 performs steps S724˜S728. Namely, in the server 110, the loading request is received and sorted in to the waiting queue 2, and the waiting queue 2 is processed after the waiting queue 1 is completed processing.

If the loading weight is greater than the N−1^{th} threshold, but smaller than the N^{th} threshold, the handheld electronic apparatus 120 performs step S732, and then, the server 110 performs steps S734˜S738. Namely, in the server 110, the loading request is received and sorted into the waiting queue N, and then, the waiting queue N is processed after the waiting queue N−1 is completed processing.

Likewise, if the loading weight is greater than the N^{th} threshold, the handheld electronic apparatus 120 performs step S742, and then the server 110 performs steps S744˜S748. Namely, in the server 110, the loading request is received and sorted into the waiting queue N+1, and then, the waiting queue N+1 after the waiting queue N is completed processing.

For example, given that the current time is 8:00 a.m., and the target item is Chinese, of which the class time is 8:30 a.m. Chinese belongs to an initiative category and has a weighted value of −1000. In addition, for descriptive convenience, the loading weight is calculated merely by the weighted value plus the time difference. Moreover, in this case where there are three thresholds (i.e. N=3), if the 1^{st} threshold is −900, the 2^{nd} threshold is 0 and the 3^{rd} threshold is 1000. Accordingly, it is known that the time difference between the current time and the class time of the target item is 30 minutes, the loading weight is 30+(−1000), i.e. −970. Thereafter, the loading weight of −970 is compared with the 1^{st} threshold of −900, and step 712 is performed, such that the target item of Chinese is determined as having the priority degree 1, and the loading request is transmitted to the server 110. Afterward, the loading request is received by the server 110, as shown in step S714. Then, in step S716, the loading request is sorted into the waiting queue 1, and in step S718, the waiting queue 1 has the priority to be processed so that the teaching material data corresponding to the target item is provided to the handheld electronic apparatus 120.

Another example is illustrated herein. Given that the current time is 8:00 a.m., and another target item is supplementary teaching material data of Chinese, which belongs to the passive category, the class time thereof is 8:30 a.m., and the weighted value thereof is 1000. Besides, the other given requirements are the same as the above. Accordingly, the time difference between the current time and the class time of the target item is 30 minutes, the loading weight is 30+1000, i.e. 1030. Thereafter, the loading weight of 1030 is compared one by one with the 1^{st} threshold of −900, the 2^{nd} threshold of 0, the 3^{rd} threshold of 1000, and step S742 is performed such that the target item of the supplementary teaching material data of Chinese is determined as having the priority degree 4, and the loading request is transmitted to the server 110. Afterward, the loading request is received by the server 110, as shown in step S744. Then, in step S746, the loading request is sorted into the waiting queue 4, and in step S748, the waiting queue 4 is executed after the waiting queue 3 is completed processing so that the teaching material data corresponding to the target item is provided to the handheld electronic apparatus 120.

Likewise, after the second processing unit 310 sorts the loading request into the corresponding waiting queue based on the priority degree, the waiting queue 1 is processed first, and the waiting queue 2 is processed after the waiting queue 1 is completed processing, and so forth. That is to say, the processing priority is waiting queue 1>waiting queue 2> . . . waiting queue N>waiting queue N+1.

Based on the above, according to the above-described embodiments, the priority for downloading teaching material items is decided according to the importance thereof, such that the server can determine the transmission orders to avoid the important teaching material item being delayed for downloading. Accordingly, the server can serve downloading in the fastest speed according to the priority. The loading weight is calculates by using the algorithms, the time difference and the importance degrees of the weighted values are adjusted by using parameters so as to adjust the loading weight. Accordingly, the reliability of the loading weight is enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method of downloading teaching material, applicable to a handheld electronic apparatus, comprising:
displaying a list of teaching material information, comprising a plurality of teaching material items;
reading a class time of a target item to be downloaded, wherein the target item is one of the teaching material items;
calculating a time difference between a current time and the class time;
calculating a loading weight of the target item according to the time difference and a weighted value of the target item; and
transmitting a loading request having the loading weight to a server to allow the server to determine a transmission order of a teaching material data corresponding to the target item.

2. The method of downloading teaching material according to claim 1, wherein attributes of the teaching material items comprise an initiative category and a passive category, and after the step of displaying the list of teaching material information, the method further comprises:
determining whether the teaching material items comprise any teaching material item belonging to the initiative category; and
if one of the teaching material items belongs to the initiative category, applying the teaching material item belonging to the initiative category as the target item directly.

3. The method of downloading teaching material according to claim 2, wherein after the step of displaying the list of teaching material information, the method further comprises:
determining whether teaching material items belonging to the passive category are selected; and
if one of the teaching material items belonging to the passive category is selected, applying the selected teaching material item belonging to the passive category as the target item.

4. The method of downloading teaching material according to claim 1, wherein in the step of calculating the loading weight of the target item according to the time difference and the weighted value of the target item, the loading weight is calculated based on
W=aT+bV,
wherein W represents the loading weight, T represents the time difference, V represents the weighted value, and a and b respectively represent an importance degree of the time difference and an importance degree of the weighted value, wherein a plus b is equal to 1.

5. The method of downloading teaching material according to claim 1, wherein after the step of calculating the loading weight of the target item, the method further comprises:
comparing the loading weight with a plurality of thresholds to obtain a priority degree of the loading weight; and
packaging the priority degree into the loading request so as to transmit the loading request to the server.

6. A method of downloading teaching material, applicable to a system of downloading teaching material, the system of downloading teaching material comprising a handheld electronic apparatus and a server, the method comprising:
transmitting a loading request to the server via the handheld electronic apparatus, the steps comprising:
applying one of a plurality of teaching material items as a target item, calculating a time difference between a current time and a class time of the target item;
calculating a loading weight according to the time difference and a weighted value of the target item; and
generating the loading request having the loading weight and transmitting the generated loading request to the server; and
receiving the loading request via the server to transmit a teaching material data corresponding to the target item to the handheld electronic apparatus, the steps comprising:
obtaining a priority degree of the target item according to the loading request; and
sorting the loading request into a waiting queue based on the priority degree to process the loading request according to a transmission order corresponding to the waiting queue.

7. The method of downloading teaching material according to claim 6, wherein before the step of transmitting the loading request having the loading weight to the server, the method further comprising:
providing a list of teaching material information to the handheld electronic apparatus by the server, wherein the list of teaching material information comprises the teaching material items.

8. The method of downloading teaching material according to claim 7, wherein attributes of the teaching material items comprise an initiative category and a passive category, and after the step of displaying the list of teaching material information to the handheld electronic apparatus by the server, the method applicable to the handheld electronic apparatus further comprises:
determining whether the teaching material items comprise any teaching material item belonging to the initiative category; and
if one of the teaching material items belongs to the initiative category, applying the teaching material item belonging to the initiative category as the target item.

9. The method of downloading teaching material according to claim 7, wherein after the step of providing the list of the teaching material information to the handheld electronic apparatus by the server, the method applicable to the handheld electronic apparatus further comprises:
determining whether teaching material items belonging to the passive category are selected; and
if one of the teaching material items belonging to the passive category is selected, applying the selected teaching material item belonging to the passive category as the target item.

10. The method of downloading teaching material according to claim 6, wherein in the step of calculating the loading weight of the target item according to the time difference and the weighted value of the target item, the loading weight is calculated based on
W=aT+bV;
wherein W represents the loading weight, T represents the time difference, V represents the weighted value, and a and b respectively represent an importance degree of the time difference and an importance degree of the weighted value, wherein a plus b is equal to 1.

11. The method of downloading teaching material according to claim 6, wherein after the step of calculating the loading weight, the method further comprises:
comparing the loading weight with a plurality of thresholds to obtain a priority degree of the loading weight; and
packaging the priority degree into the loading request so as to transmit the loading request to the server.

12. A system of downloading teaching material; comprising:
a handheld electronic apparatus, comprising:
a first processing unit, applying one of a plurality of teaching material items as a target item to calculate a time difference between a current time a class time of the target item and calculating a loading weight according to the time difference and a weighted value of the target item to generate a loading request having the loading weight; and
a first communication unit, coupled to the first processing unit and transmitting the loading request; and
a server, comprising:
a storing unit, comprising a teaching material database and a plurality of waiting queues, wherein the teaching material database comprises teaching material data corresponding to each of the teaching material items, and each of the waiting queues has different transmission orders;
a second communication unit, receiving the loading request; and
a second processing unit, coupled to the storing unit and the second communication unit, obtaining a priority degree of the target item according to the loading request, sorting the loading request into one of the corresponding waiting queues based on the priority degree to process the loading request according to the transmission order corresponding to the waiting queue.

13. The system of downloading teaching material according to claim 12, where in the server provides a list of teaching material information to the handheld electronic apparatus, and the list of teaching material information comprises the teaching material items.

14. The system of downloading teaching material according to claim 12, wherein attributes of the teaching material items comprise an initiative category and a passive category, in the handheld electronic apparatus, if one of the teaching material items belongs to the initiative category, the first processing unit applies the teaching material item belonging to the initiative category as the target item, and if one of the teaching material items belonging to the passive category is selected, the first processing unit applies the selected teaching material item belonging to the passive category as the target item.

15. The system of downloading teaching material according to claim 12, wherein in the step where the first processing unit calculates the loading weight according to the time difference and the weighted value of the target item is based on
W=aT+bV,
wherein W represents the loading weight, T represents the time difference, V represents the weighted value, and a and b respectively represent an importance degree of the time difference and an importance degree of the weighted value, wherein a plus b is equal to 1.

16. The system of downloading teaching material according to claim 12, wherein the first processing unit compares the loading weight with a plurality of thresholds to obtain a priority degree of the loading weight and packages the priority degree into the loading request so as to transmit the loading request to the server.
